(19) United States
(12) Patent Application Publication
(10) Pub. No.: US 2006/0059204 A1
(43) Pub. Date: Mar. 16, 2006

(54) System and method for selectively indexing file system content

(76) Inventors: Dhrubajyoti Borthakur, San Jose, CA (US); Serge Pashenkov, Redwood City, CA (US)

Correspondence Address: B. Noel Kivlin;Meyertons, Hood, Kivlin, Kowert & Goetzel, P.C., P.O. Box 398, Austin, TX, 78767-0398, US

(21) Appl. No.: 10/926,427

(22) Filed: Aug. 25, 2004

(51) Int. Cl. G06F 17/30

(52) U.S. Cl. 707/200

(57) ABSTRACT

A system and method for selectively indexing file system content. In one embodiment, the system may include a storage device configured to store data and a file system configured to manage access to the storage device and to store file system content, where the file system content may include a file associated with a pathname. The system may further include a search engine configured to construct an index of the file system content, where constructing the index includes generating index information associated with the file. In response to the file being moved or renamed, the search engine may be further configured to preserve existing index information associated with the file without regenerating the existing index information.

### BACKGROUND

1. Field of the Invention

This invention relates to computer systems and, more particularly, to file-based storage systems.

2. Description of the Related Art

Computer systems often process large quantities of information, including application data and executable code configured to process such data. In numerous embodiments, computer systems provide various types of mass storage devices configured to store data, such as magnetic and optical disk drives, tape drives, etc. To provide a regular and systematic interface through which to access their stored data, such storage devices are frequently organized into hierarchies of files by software such as an operating system. Often a file defines a minimum level of data granularity that a user can manipulate within a storage device, although various applications and operating system processes may operate on data within a file at a lower level of granularity than the entire file.

As the number of files and the amount of data stored therein increases, efficiently locating and retrieving file data becomes more challenging. Various kinds of search technology may be employed to locate data satisfying specified characteristics, such as file names or data patterns stored within files. To improve search performance, some search technologies employ indexing of the target data to be searched (e.g., file data), through which desired content may be more readily accessed.

However, creating indexes may consume substantial processing time and resources, particularly if the amount of data to be indexed is large and changes frequently. Therefore, unnecessarily indexing content may result in a waste of processing time and resources, potentially degrading system performance.

### SUMMARY

Various embodiments of a system and method for selectively indexing file system content are disclosed. In one embodiment, the system may include a storage device configured to store data and a file system configured to manage access to the storage device and to store file system content, where the file system content may include a file associated with a pathname. The system may further include a search engine configured to construct an index of the file system content, where constructing the index includes generating index information associated with the file. In response to the file being moved or renamed, the search engine may be further configured to preserve existing index information associated with the file without regenerating the existing index information.

In one specific implementation of the system, the file system may be further configured to assign a unique file identifier to the file. In another specific implementation of the system, the index information may include the unique file identifier and a last modification time corresponding to the unique file identifier, and the search engine may be further configured to search file system content by unique file identifiers.

A method is further contemplated that, in one embodiment, includes storing file system content, where the file system content includes a file associated with a pathname; constructing an index of the file system content, where constructing the index includes generating index information associated with the file; and, in response to the file being moved or renamed, preserving existing index information associated with the file without regenerating the existing index information.

### BRIEF DESCRIPTION OF THE DRAWINGS

FIG. 1 is a block diagram illustrating one embodiment of a storage system.

FIG. 2 is a block diagram illustrating one embodiment of a software-based storage system architecture and its interface to storage devices.

FIG. 3 is a block diagram illustrating one embodiment of a storage management system.

FIG. 4 is a block diagram illustrating one embodiment of a file system configured to store files and associated metadata.

FIG. 5 is a block diagram illustrating one embodiment of a search engine which, in response to a file being moved or renamed, is configured to preserve existing index information associated with the file without regenerating existing index information.

FIG. 6 is a flow diagram illustrating one embodiment of a method of search engine reindexing.

FIG. 7 is a block diagram illustrating another embodiment of a search engine which, in response to a file being moved or renamed, is configured to preserve existing index information associated with the file without regenerating existing index information.

FIG. 8 is a block diagram illustrating one embodiment of a unique file identifier.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Computer System Overview

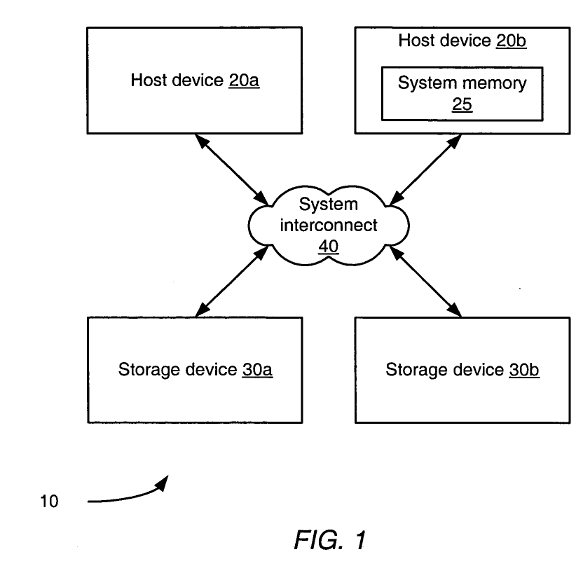

Turning now to FIG. 1, a block diagram of one embodiment of a computer system is shown. In the illustrated embodiment, system 10 includes a plurality of host devices 20a and 20b coupled to a plurality of storage devices 30a and 30b via a system interconnect 40. Further, host device 20b includes a system memory 25 in the illustrated embodiment. For simplicity of reference, elements referred to herein by a reference number followed by a letter may be referred to collectively by the reference number alone. For example, host devices 20a and 20b and storage devices 30a and 30b may be referred to collectively as host devices 20 and storage devices 30.

In various embodiments of system 10, host devices 20 may be configured to access data stored on one or more of storage devices 30. In one embodiment, system 10 may be implemented within a single computer system, for example as an integrated storage server. In such an embodiment, for example, host devices 20 may be individual processors, system memory 25 may be a cache memory such as a static RAM (SRAM), storage devices 30 may be mass storage devices such as hard disk drives or other writable or rewritable media, and system interconnect 40 may include a peripheral bus interconnect such as a Peripheral Component Interface (PCI) bus. In some such embodiments, system interconnect 40 may include several types of interconnect between host devices 20 and storage devices 30. For example, system interconnect 40 may include one or more processor buses (not shown) configured for coupling to host devices 20, one or more bus bridges (not shown) configured to couple the processor buses to one or more peripheral buses, and one or more storage device interfaces (not shown) configured to couple the peripheral buses to storage devices 30. Storage device interface types may in various embodiments include the Small Computer System Interface (SCSI), AT Attachment Packet Interface (ATAPI), Firewire, and/or Universal Serial Bus (USB), for example, although numerous alternative embodiments including other interface types are possible and contemplated.

In an embodiment of system 10 implemented within a single computer system, system 10 may be configured to provide most of the data storage requirements for one or more other computer systems (not shown), and may be configured to communicate with such other computer systems. In an alternative embodiment, system 10 may be configured as a distributed storage system, such as a storage area network (SAN), for example. In such an embodiment, for example, host devices 20 may be individual computer systems such as server systems, system memory 25 may be comprised of one or more types of dynamic RAM (DRAM), storage devices 30 may be standalone storage nodes each including one or more hard disk drives or other types of storage, and system interconnect 40 may be a communication network such as Ethernet or Fibre Channel. A distributed storage configuration of system 10 may facilitate scaling of storage system capacity as well as data bandwidth between host and storage devices.

In still another embodiment, system 10 may be configured as a hybrid storage system, where some storage devices 30 are integrated within the same computer system as some host devices 20, while other storage devices 30 are configured as standalone devices coupled across a network to other host devices 20. In such a hybrid storage system, system interconnect 40 may encompass a variety of interconnect mechanisms, such as the peripheral bus and network interconnect described above.

It is noted that although two host devices 20 and two storage devices 30 are illustrated in FIG. 1, it is contemplated that system 10 may have an arbitrary number of each of these types of devices in alternative embodiments. Also, in some embodiments of system 10, more than one instance of system memory 25 may be employed, for example in other host devices 20 or storage devices 30. Further, in some embodiments, a given system memory 25 may reside externally to host devices 20 and storage devices 30 and may be coupled directly to a given host device 20 or storage device 30 or indirectly through system interconnect 40.

In many embodiments of system 10, one or more host devices 20 may be configured to execute program instructions and to reference data, thereby performing a computational function. In some embodiments, system memory 25 may be one embodiment of a computer-accessible medium configured to store such program instructions and data. However, in other embodiments, program instructions and/or data may be received, sent or stored upon different types of computer-accessible media. Generally speaking, a computer-accessible medium may include storage media or memory media such as magnetic or optical media, e.g., disk or CD-ROM included in system 10 as storage devices 30. A computer-accessible medium may also include volatile or non-volatile media such as RAM (e.g. SDRAM, DDR SDRAM, RDRAM, SRAM, etc.), ROM, etc, that may be included in some embodiments of system 10 as system memory 25. Further, a computer-accessible medium may include transmission media or signals such as electrical, electromagnetic, or digital signals, conveyed via a communication medium such as network and/or a wireless link, which may be included in some embodiments of system 10 as system interconnect 40.

In some embodiments, program instructions and data stored within a computer-accessible medium as described above may implement an operating system that may in turn provide an environment for execution of various application programs. For example, a given host device 20 may be configured to execute a version of the Microsoft Windows operating system, the Unix/Linux operating system, the Apple Macintosh operating system, or another suitable operating system. Additionally, a given host device may be configured to execute application programs such as word processors, web browsers and/or servers, email clients and/or servers, and multimedia applications, among many other possible applications.

During execution on a given host device 20, either the operating system or a given application may generate requests for data to be loaded from or stored to a given storage device 30. For example, code corresponding to portions of the operating system or an application itself may be stored on a given storage device 30, so in response to invocation of the desired operation system routine or application program, the corresponding code may be retrieved for execution. Similarly, operating system or application execution may produce data to be stored

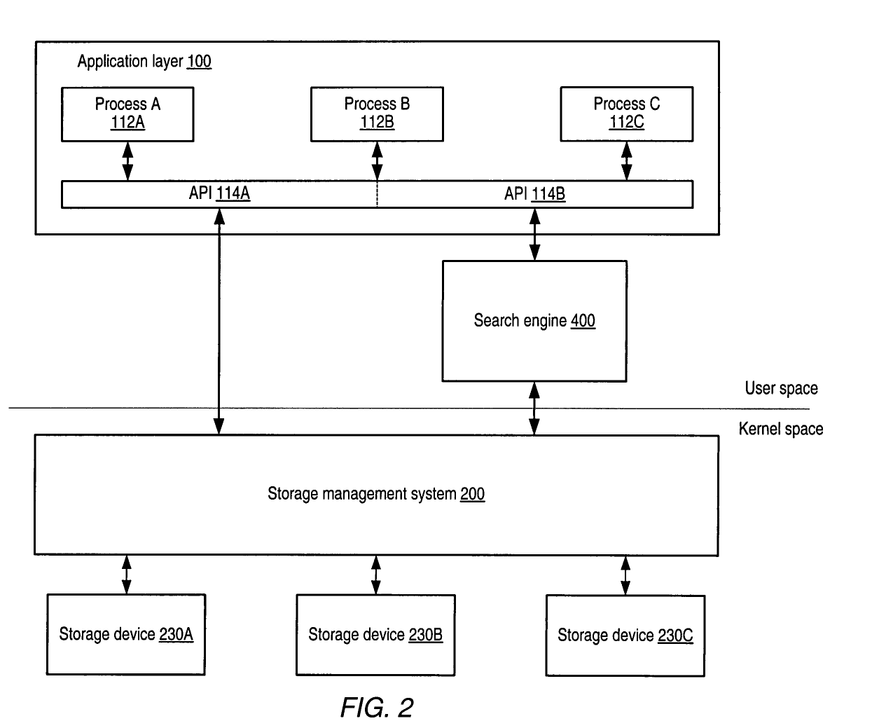

In some embodiments, the movement and processing of data stored on storage devices 30 may be managed by a software-based storage management system. One such embodiment is illustrated in FIG. 2, which shows an application layer 100 interfacing to a plurality of storage devices 230A-C via a storage management system 200. Additionally, application layer 100 interfaces to a search engine 400, which in turn interfaces to storage management system 200. Some modules illustrated within FIG. 2 may be configured to execute in a user execution mode or “user space”, while others may be configured to execute in a kernel execution mode or “kernel space.” In the illustrated embodiment, application layer 100 includes a plurality of user space software processes 112A-C. Each process interfaces to kernel space storage management system 200 via an application programming interface (API) 114A. In turn, storage management system 200 interfaces to storage devices 230A-C. Additionally, each process interfaces to user space search engine 400 via an API 114B. The functionality associated with various embodiments of storage management system 200 and search engine 400 is described in greater detail below.

It is contemplated that in some embodiments, an arbitrary number of processes 112 and/or storage devices 230 may be implemented. In one embodiment, each of processes 112 may correspond to a given user application, and each may be configured to access storage devices 230A-C through calls to API 114A. APIs 114A-B provides processes 112 with access to various components of storage management system 200 and search engine 400. For example, in one embodiment APIs 114A-B may include function calls exposed by storage management system 200 or search engine 400 that a given process 112 may invoke, while in other embodiments APIs 114A-B may support other types of interprocess communication. In one embodiment, storage devices 230 may be illustrative of storage devices 30 of FIG. 1. Additionally, in one embodiment, any of the components of storage management system 200, search engine 400 and/or any of processes 112 may be configured to execute on one or more host devices 20 of FIG. 1, for example as program instructions and data stored within a computer-accessible medium such as system memory 25 of FIG. 1.

Storage Management System and File System

As just noted, in some embodiments storage management system 200 may provide data and control structures for organizing the storage space provided by storage devices 230 into files. In various embodiments, the data structures may include one or more tables, lists, or other records configured to store information such as, for example, the identity of each file, its location within storage devices 230 (e.g., a mapping to a particular physical location within a particular storage device), as well as other information about each file as described in greater detail below. Also, in various embodiments, the control structures may include executable routines for manipulating files, such as, for example, function calls for changing file identities and for modifying file content. Collectively, these data and control structures may be referred to herein as a file system, and the particular data formats and protocols implemented by a given file system may be referred to herein as the format of the file system.

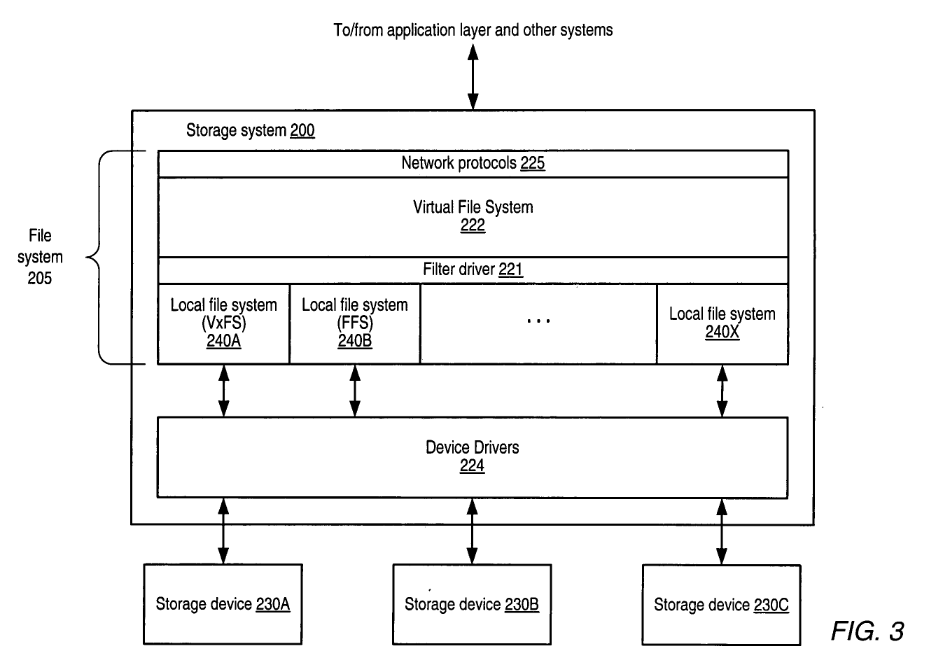

In some embodiments, a file system may be integrated into an operating system such that any access to data stored on storage devices 230 is governed by the control and data structures of the file system. Different operating systems may implement different native file systems using different formats, but in some embodiments, a given operating system may include a file system that supports multiple different types of file system formats, including file system formats native to other operating systems. In such embodiments, the various file system formats supported by the file system may be referred to herein as local file systems. Additionally, in some embodiments, a file system may be implemented using multiple layers of functionality arranged in a hierarchy, as illustrated in FIG. 3.

FIG. 3 illustrates one embodiment of storage management system 200. In the illustrated embodiment, storage management system includes a file system 205 configured to interface with one or more device drivers 224, which are in turn configured to interface with storage devices 230. As illustrated in FIG. 2, the components of storage management system 200 may be configured to execute in kernel space; however, it is contemplated that in some embodiments, some components of storage management system 200 may be configured to execute in user space. Also, in one embodiment, any of the components of storage management system 200 may be configured to execute on one or more host devices 20 of FIG. 1, for example as program instructions and data stored within a computer-accessible medium such as system memory 25 of FIG. 1.

As described above with respect to system 10 of FIG. 1, a given host device 20 may reside in a different computer system from a given storage device 30, and may access that storage device via a network. Likewise, with respect to storage management system 200, in one embodiment a given process such as process 112A may execute remotely and may access storage devices 230 over a network. In the illustrated embodiment, file system 205 includes network protocols 225 to support access to the file system by remote processes. In some embodiments, network protocols 225 may include support for the Network File System (NFS) protocol or the Common Internet File System (CIFS) protocol, for example, although it is contemplated that any suitable network protocol may be employed, and that multiple such protocols may be supported in some embodiments.

File system 205 may be configured to support a plurality of local file systems. In the illustrated embodiment, file system 205 includes a VERITAS (VXFS) format local file system 240A, a Berkeley fast file system (FFS) format local file system 240B, and a proprietary (X) format local file system 240X. However, it is contemplated that in other embodiments, any number or combination of local file system formats may be supported by file system 205. To provide a common interface to the various local file systems 240, file system 205 includes a virtual file system 222. In one embodiment, virtual file system 222 may be configured to translate file system operations originating from processes 112 to a format applicable to the particular local file system 240 targeted by each operation. Additionally, in the illustrated embodiment storage management system 200 includes device drivers 224 through which local file systems 240 may access storage devices 230. Device drivers 224 may implement data transfer protocols specific to the types of interfaces employed by storage devices 230. For example, in one embodiment device drivers 224 may provide support for transferring data across SCSI and ATAPI interfaces, though in other embodiments device drivers 224 may support other types and combinations of interfaces.

In the illustrated embodiment, file system 205 also includes filter driver 221. In some embodiments, filter driver 221 may be configured to monitor each operation entering file system 205 and, subsequent to detecting particular types of operations, to cause additional operations to be performed or to alter the behavior of the detected operation. For example, in one embodiment filter driver 221 may be configured to combine multiple write operations into a single write operation to improve file system performance. In another embodiment, filter driver 221 may be configured to compute a signature of a file subsequent to detecting a write to that file. In still another embodiment, filter driver 221 may be configured to store and/or publish information, such as records, associated with particular files subsequent to detecting certain kinds of operations on those files, as described in greater detail below. It is contemplated that in some embodiments, filter driver 221 may be configured to implement one or more combinations of the aforementioned operations, including other filter operations not specifically mentioned.

An embodiment of filter driver 221 that is configured to detect file system operations as they are requested or processed may be said to perform “in-band” detection of such operations. Alternatively, such detection may be referred to as being synchronous with respect to occurrence of the detected operation or event. In some embodiments, a processing action taken in response to in-band detection of an operation may affect how the operation is completed. For example, in-band detection of a file read operation might result in cancellation of the operation if the source of the operation is not sufficiently privileged to access the requested file. In some embodiments, in-band detection of an operation may not lead to any effect on the completion of the operation itself, but may spawn an additional operation, such as to record the occurrence of the detected operation in a metadata record as described below.

By contrast, a file system operation or event may be detected subsequent to its occurrence, such that detection may occur after the operation or event has already completed. Such detection may be referred to as “out of band” or asynchronous with respect to the detected operation or event. For example, a user process 112 may periodically check a file to determine its length. The file length may have changed at any time since the last check by user process 112, but the check may be out of band with respect to the operation that changed the file length. In some instances, it is possible for out of band detection to fail to detect certain events. Referring to the previous example, the file length may have changed several times since the last check by user process 112, but only the last change may be detected.

It is noted that although an operation or event may be detected in-band, an action taken in response to such detection may occur either before or after the detected operation completes. Referring to the previous example, in one embodiment each operation to modify the length of the checked file may be detected in-band and recorded. User process 112 may be configured to periodically inspect the records to determine the file length. Because length-modifying operations were detected and recorded in-band, user process 112 may take each such operation into account, even though it may be doing so well after the occurrence of these operations.

It is noted that filter driver 221 is part of file system 205 and not an application or process within user space 210. Consequently, filter driver 221 may be configured to operate independently of applications and processes within the user space 210. Alternatively, or in addition to the above, filter driver 221 may be configured to perform operations in response to requests received from applications or processes within the user space 210.

It is further noted that in some embodiments, kernel space 220 may include processes (not shown) that generate accesses to storage devices 230, similar to user space processes 112. In such embodiments, processes executing in kernel space 220 may be configured to access file system 205 through a kernel-mode API (not shown), in a manner similar to user space processes 112. Thus, in some embodiments, all accesses to storage devices 230 may be processed by file system 205, regardless of the type or space of the process originating the access operation.

Numerous alternative embodiments of storage management system 200 and file system 205 are possible and contemplated. For example, file system 205 may support different numbers and formats of local file systems 240, or only a single local file system 240. In some embodiments, network protocol 225 may be omitted or integrated into a portion of storage management system 200 external to file system 205. Likewise, in some embodiments virtual file system 222 may be omitted or disabled, for example if only a single local file system 240 is in use. Additionally, in some embodiments filter driver 221 may be implemented within a different layer of file system 205. For example, in one embodiment, filter driver 221 may be integrated into virtual file system 222, while in another embodiment, an instance of filter driver 221 may be implemented in each of local file systems 240.

Files and Metadata

As described above, file system 205 may be configured to manage access to data stored on storage devices 230, for example as a plurality of files stored on storage devices 230. In many embodiments, each stored file may have an associated identity used by the file system to distinguish each file from other files. In one embodiment of file system 205, the identity of a file may be a file name, which may for example include a string of characters such as “filename.txt”. However, in embodiments of file system 205 that implement a file hierarchy, such as a hierarchy of folders or directories, all or part of the file hierarchy may be included in the file identity. For example, a given file named “file1.txt” may reside in a directory “smith” that in turn resides in a directory “users”. The directory “users” may reside in a directory “test1” that is a top-level or root-level directory within file system 205. In some embodiments, file system 205 may define a single “root directory” to include all root-level directories, where no higher-level directory includes the root directory. In other embodiments, multiple top-level directories may coexist such that no higher-level directory includes any top-level directory. The names of the specific folders or directories in which a given file is located may be referred to herein as the given file's path or path name.

In some embodiments of file system 205 that implement a file hierarchy, a given file's identity may be specified by listing each directory in the path of the file as well as the file name. Referring to the example given above, the identity of the given instance of the file named “file1.txt” may be specified as “/test1/users/smith/file1.txt”. It is noted that in some embodiments of file system 205, a file name alone may be insufficient to uniquely identify a given file, whereas a fully specified file identity including path information may be sufficient to uniquely identify a given file. There may, for example, exist a file identified as “/test2/users/smith/file1.txt” that, despite sharing the same file name as the previously mentioned file, is distinct by virtue of its path. It is noted that other methods of representing a given file identity using path and file name information are possible and contemplated. For example, different characters may be used to delimit directory/folder names and file names, or the directory/folder names and file names may be specified in a different order.

The files managed by file system 205 may store application data or program information, which may collectively be referred to as file data, in any of a number of encoding formats. For example, a given file may store plain text in an ASCII-encoded format or data in a proprietary application format, such as a particular word processor or spreadsheet encoding format. Additionally, a given file may store video or audio data or executable program instructions in a binary format. It is contemplated that numerous other types of data and encoding formats, as well as combinations of data and encoding formats, may be used in files as file data.

In addition to managing access to storage devices, the various files stored on storage devices, and the file data in those files as described above, in some embodiments file system 205 may be configured to store information corresponding to one or more given files, which information may be referred to herein as metadata. Generally speaking, metadata may encompass any type of information associated with a file. In various embodiments, metadata may include information such as (but not limited to) the file identity, size, ownership, and file access permissions. Metadata may also include free-form or user-defined data such as records corresponding to file system operations, as described in greater detail below. In some embodiments, the information included in metadata may be predefined (i.e., hardcoded) into file system 205, for example as a collection of metadata types defined by a vendor or integrator of file system 205. In other embodiments, file system 205 may be configured to generate new types of metadata definitions during operation. In still other embodiments, one or more application processes 112 external to file system 205 may define new metadata to be managed by file system 205, for example via an instance of API 114 defined for that purpose. It is contemplated that combinations of such techniques of defining metadata may be employed in some embodiments. Metadata corresponding to files (however the metadata is defined) as well as the data content of files may collectively be referred to herein as file system content.

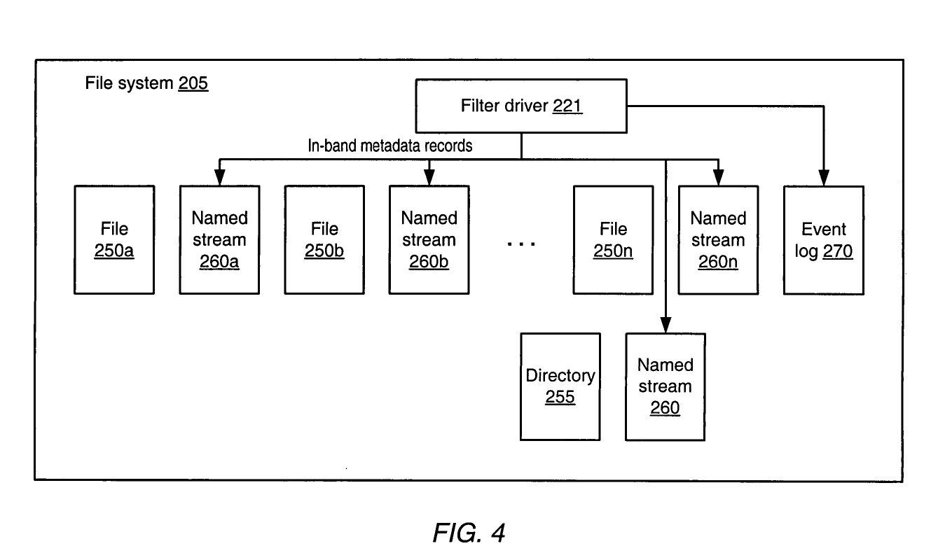

FIG. 4 illustrates one embodiment of a file system configured to store files and associated metadata (i.e., to store file system content). The embodiment of file system 205 shown in FIG. 4 may include those elements illustrated in the embodiment of FIG. 3; however, for sake of clarity, some of these elements are not shown. In the illustrated embodiment, file system 205 includes filter driver 221, an arbitrary number of files 250a-n, a directory 255, a respective named stream 260a-n associated with each of files 250a-n, a respective named stream 260 associated with directory 255, and an event log 270. It is noted that a generic instance of one of files 250a-n or named streams 260a-n may be referred to respectively as a file 250 or a named stream 260, and that files 250a-n and named streams 260a-n may be referred to collectively as files 250 and named streams 260, respectively. As noted above, files 250 and named streams 260 may collectively be referred to as file system content. In some embodiments, directory 255 may also be included as part of file system content.

Files 250 may be representative of files managed by file system 205, and may in various embodiments be configured to store various types of data and program instructions as described above. In hierarchical implementations of file system 205, one or more files 250 may be included in a directory 255 (which may also be referred to as a folder). In various embodiments, an arbitrary number of directories 255 may be provided, and some directories 255 may be configured to hierarchically include other directories 255 as well as files 250. In the illustrated embodiment, each of files 250 and directory 255 has a corresponding named stream 260. Each of named streams 260 may be configured to store metadata pertaining to its corresponding file. It is noted that files 250, directory 255 and named streams 260 may be physically stored on one or more storage devices, such as storage devices 230 of FIG. 2. However, for purposes of illustration, files 250, directory 255 and named streams 260 are shown as conceptually residing within file system 205. Also, it is contemplated that in some embodiments directory 255 may be analogous to files 250 from the perspective of metadata generation, and it is understood that in such embodiments, references to files 250 in the following discussion may also apply to directory 255.

In some embodiments, filter driver 221 may be configured to access file data stored in a given file 250. For example, filter driver 221 may be configured to detect read and/or write operations received by file system 205, and may responsively cause file data to be read from or written to a given file 250 corresponding to the received operation. In some embodiments, filter driver 221 may be configured to generate in-band metadata corresponding to a given file 250 and to store the generated metadata in the corresponding named stream 260. For example, upon detecting a file write operation directed to given file 250, filter driver 221 may be configured to update metadata corresponding to the last modified time of given file 250 and to store the updated metadata within named stream 260. Also, in some embodiments filter driver 221 may be configured to retrieve metadata corresponding to a specified file on behalf of a particular application.

Metadata may be generated in response to various types of file system activity initiated by processes 112 of FIG. 2. In some embodiments, the generated metadata may include records of arbitrary complexity. For example, in one embodiment filter driver 221 may be configured to detect various types of file manipulation operations such as file create, delete, rename, and/or copy operations as well as file read and write operations. In some embodiments, such operations may be detected in-band as described above. After detecting a particular file operation, filter driver 221 may be configured to generate a record of the operation and store the record in the appropriate named stream 260 as metadata of the file 250 targeted by the operation.

More generally, any operation that accesses any aspect of file system content, such as, for example, reading or writing of file data or metadata, or any or the file manipulation operations previously mentioned, may be referred to as a file system content access event. In one embodiment, filter driver 221 may be configured to generate a metadata record in response to detecting a file system content access event. It is contemplated that in some embodiments, access events targeting metadata may themselves generate additional metadata. As described in greater detail below, in the illustrated embodiment, event log 270 may be configured to store records of detected file system content access events independently of whether additional metadata is stored in a particular named stream 260 in response to event detection.

The stored metadata record may in various embodiments include various kinds of information about the file 250 and the operation detected, such as the identity of the process generating the operation, file identity, file type, file size, file owner, and/or file permissions, for example. In one embodiment, the record may include a file signature indicative of the content of file 250. A file signature may be a hash-type function of all or a portion of the file contents and may have the property that minor differences in file content yield quantifiably distinct file signatures. For example, the file signature may employ the Message Digest 5 (MD5) algorithm, which may yield different signatures for files differing in content by as little as a single bit, although it is contemplated that any suitable signature-generating algorithm may be employed. The record may also include additional information other than or instead of that previously described.

In one embodiment, the metadata record stored by filter driver 221 subsequent to detecting a particular file operation may be generated and stored in a format that may include data fields along with tags that describe the significance of an associated data field. Such a format may be referred to as a “self-describing” data format. For example, a data element within a metadata record may be delimited by such tag fields, with the generic syntax:
<descriptive_tag>data element</descriptive_tag>
   where the “descriptive_tag” delimiter may describe some aspect of the “data element” field, and may thereby serve to structure the various data elements within a metadata record. It is contemplated that in various embodiments, self-describing data formats may employ any of a variety of syntaxes, which may include different conventions for distinguishing tags from data elements.

Self-describing data formats may also be extensible, in some embodiments. That is, the data format may be extended to encompass additional structural elements as required. For example, a non-extensible format may specify a fixed structure to which data elements must conform, such as a tabular row-and-column data format or a format in which the number and kind of tag fields is fixed. By contrast, in one embodiment, an extensible, self-describing data format may allow for an arbitrary number of arbitrarily defined tag fields used to delimit and structure data. In another embodiment, an extensible, self-describing data format may allow for modification of the syntax used to specify a given data element. In some embodiments, an extensible, self-describing data format may be extended by a user or an application while the data is being generated or used.

In one embodiment, Extensible Markup Language (XML) format, or any data format compliant with any version of XML, may be used as an extensible, self-describing format for storing metadata records, although it is contemplated that in other embodiments, any suitable format may be used, including formats that are not extensible or self-describing. XML-format records may allow arbitrary definition of record fields, according to the desired metadata to be recorded. One example of an XML-format record is as follows:

<record sequence=“1”>

<path>/test1/foo.pdf</path>
<type>application/pdf</type>
<user id=1598>username</user>
<group id=119>groupname</group>
<perm>rw-r- -r- -</perm>
<md5>d41d8cd98f00b204e9800998ecf8427e</md5>
<size>0</size>

</record>

Such a record may be appended to the named stream (for example, named stream 260a) associated with the file (for example, file 250a) having the file identity “/test1/foo.pdf” subsequent to, for example, a file create operation. In this case, the number associated with the “record sequence” field indicates that this record is the first record associated with file 250a. The “path” field includes the file identity, and the “type” field indicates the file type, which in one embodiment may be provided by the process issuing the file create operation, and in other embodiments may be determined from the extension of the file name or from header information within the file, for example. The “user id” field records both the numerical user id and the textual user name of the user associated with the process issuing the file create operation, and the “group id” field records both the numerical group id and the textual group name of that user. The “perm” field records file permissions associated with file 250a in a format specific to the file system 205 and/or the operating system. The “md5” field records an MD5 signature corresponding to the file contents, and the “size” field records the length of file 250a in bytes. It is contemplated that in alternative embodiments, filter driver 221 may store records corresponding to detected operations where the records include more or fewer fields, as well as fields having different definitions and content. It is also contemplated that in some embodiments filter driver 221 may encapsulate data read from a given file 250 within the XML format, such that read operations to files may return XML data regardless of the underlying file data format. Likewise, in some embodiments filter driver 221 may be configured to receive XML format data to be written to a given file 250. In such an embodiment, filter driver 221 may be configured to remove XML formatting prior to writing the file data to given file 250.

It is noted that in some embodiments, metadata may be stored in a structure other than a named stream. For example, in one embodiment metadata corresponding to one or more files may be stored in another file in a database format or another format. Also, it is contemplated that in some embodiments, other software modules or components of file system 205 may be configured to generate, store, and/or retrieve metadata. For example, the metadata function of filter driver 221 may be incorporated into or duplicated by another software module.

In the illustrated embodiment, file system 205 includes event log 270. Event log 270 may be a named stream similar to named streams 260; however, rather than being associated with a particular file, event log 270 may be associated directly with file system 205. In some embodiments, file system 205 may include only one event log 270, while in other embodiments, more than one event log 270 may be provided. For example, in one embodiment of file system 205 including a plurality of local file systems 240 as illustrated in FIG. 2, one history stream per local file system 240 may be provided.

In some embodiments, filter driver 221 may be configured to store a metadata record in event log 270 in response to detecting a file system operation or event. For example, a read or write operation directed to a particular file 250 may be detected, and subsequently filter driver 221 may store a record indicative of the operation in event log 270. In some embodiments, filter driver 221 may be configured to store metadata records within event log 270 regardless of whether a corresponding metadata record was also stored within a named stream 260. In some embodiments event log 270 may function as a centralized history of all detected operations and events transpiring within file system 205.

Similar to the records stored within named stream 260, the record stored by filter driver 221 in event log 270 may in one embodiment be generated in an extensible, self-describing data format such as the Extensible Markup Language (XML) format, although it is contemplated that in other embodiments, any suitable format may be used. As an example, a given file 250a named “/test1/foo.pdf” may be created, modified, and then renamed to file 250b “/test1/destination.pdf” in the course of operation of file system 205. In one embodiment, event log 270 may include the following example records subsequent to the rename operation:

<record>

<op>create</op>
<path>/test1/foo.pdf</path>

</record>
<record>

<op>modify</op>
<path>/test1/foo.pdf</path>

</record>
<record>

<op>rename</op>
<path>/test1/destination.pdf</path>
<oldpath>/test1/foo.pdf</oldpath>

</record>

In this example, the “op” field of each record indicates the operation performed, while the “path” field indicates the file identity of the file 250a operated on. In the case of the file rename operation, the “path” field indicates the file identity of the destination file 250b of the rename operation, and the “oldpath” field indicates the file identity of the source file 250a. It is contemplated that in alternative embodiments, filter driver 221 may store within event log 270 records including more or fewer fields, as well as fields having different definitions and content.
Searching and Indexing File System Content

The file system content stored and managed by file system 205 may be accessed, for example by processes 112, in a number of different ways. As shown in FIG. 2, processes 112 may interact directly with storage management system 200 via API 114A. For example, if a process 112 knows the specific identity of a file 250 it wishes to access, it may directly open and read that file 250 via API calls provided by storage management system 200. However, in some embodiments processes 112 may desire to access file system content according to a particular criterion or set of criteria. For example, a given process 112 may be interested in identifying those files 250 that include a particular text string.

In the embodiment illustrated in FIG. 2, search engine 400 may be configured to search file system content on behalf of processes 112 and to identify content that matches specified criteria. For example, in one embodiment search engine 400 may be configured to search files 250 for text patterns or regular expressions specified by processes 112 requesting searches. If a portion of given file 250 matches a text pattern or regular expression specified for a given search, search engine 400 may include file 250 in a search result set corresponding to the given search. In some embodiments, search engine 400 may be configured to perform searches that specify a combination of terms or patterns joined with Boolean or other predicates, such as AND, OR, NOT, or NEAR. For example, a search for files satisfying the search pattern (“quarterly report” AND “FY 2003”) may return a result set including the names of those files 250 including both text strings. In various embodiments, search engine 400 may provide other features or predicates to qualify pattern matching, or may implement a query language such as a version of Structured Query Language (SQL), Extensible Markup Language (XML) Query Language (XQuery), or another suitable query language. In some embodiments, metadata corresponding to files 250 as well as the data content of files 250 may be searched.

In performing a search, search engine 400 may be configured to directly access all file system content stored by file system 205. However, if the amount of content stored is substantial, performing a brute-force search on all file system content may result in poor search performance. In some embodiments, search performance may be improved by creating one or more indexes of file system content and using these indexes to assist in evaluation of particular searches.

Generally speaking, an index may be any data structure that organizes a collection of data according to some aspect or attribute, facilitating searching of the data by the indexed aspect or attribute. For example, in one embodiment an index may be a list of names of all files 250 defined with file system 205, organized alphabetically. In some embodiments, multiple indexes of file system content may be employed. For example, if file system content is frequently searched for specific text patterns or file attributes (such as, e.g., file name, associated user, and content creation/modification time), individual indexes that sort or organize file system content by each of these patterns or attributes may be created. In some embodiments, more complex indexing schemes may be employed, including indexes that combine multiple content attributes into complex state spaces. Additionally, it is contemplated that indexes may be implemented using any suitable data structure, including lists, tables, trees, and higher-order data structures. Any information stored by an index of file system content may be generically referred to as index information, and index information extracted by or derived from file system content during the indexing process may be said to be associated with that file system content. For example, the aforementioned indexing patterns or attributes, to the extent they occur in a given file 250, may comprise index information associated with that given file.

If a file 250 is modified, previously determined index information associated with the file may become out of date. For example, a file 250 may be altered to add or remove a pattern that search engine 400 is configured to index on. In some embodiments, modification of a file 250 may result in regeneration of index information associated with that file. However, in some instances, a given file 250 may be moved from one location within file system 205 to another location, such that a different pathname becomes associated with given file 250 while the content of given file 250 remains unchanged. For example, the file “/test/foo.pdf” may be moved from the directory “test/” to the directory “/user/smith/” such that although the pathname has changed, the contents of “foo.pdf” remain the same. Such an operation may be referred to as a file move or file rename operation. A file move or rename operation may also encompass changing the name of a file 205 while preserving the file's contents, whether or not the pathname is also changed. For example, file “/test/foo.pdf” may be renamed to “/test/report.pdf” without the file's contents otherwise being altered. Generally, a file move or rename operation where file content is not modified may not alter the last modification time associated with that file.

In conventional embodiments, a search engine may interpret a file move operation as the deletion of a file from the old location and the creation of a file in the new location, and may correspondingly update its indexes by removing index information associated with the file in its old location and regenerating index information associated with the file in its new location. However, if the contents of the moved file have not changed as a result of the move operation, such removal and regeneration of index information is unnecessary. If file move/rename operations are frequent, unnecessary regeneration of index information may degrade search engine and/or overall system performance.

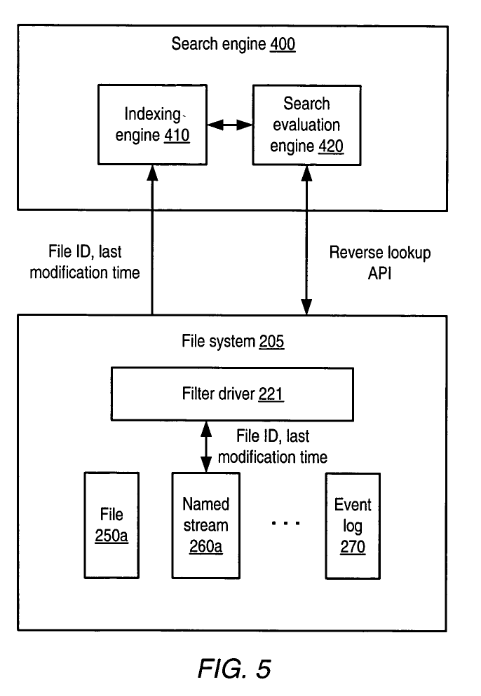

One embodiment of a search engine which, in response to a file being moved or renamed, is configured to preserve existing index information associated with the file without regenerating existing index information is illustrated in FIG. 5. In the illustrated embodiment, search engine 400 includes an indexing engine 410 and a search evaluation engine 420, each of which interface with file system 205 to transfer information. It is noted that although only file 250a and named stream 260a are shown within file system 205, it is contemplated that file system 205 may include arbitrary numbers of files 250 and named streams 260 in addition to other elements, as described above in conjunction with the description of FIG. 4. It is also noted that while specific types of information exchange are illustrated between search engine 400 and file system 205, other types of information exchange may take place within these entities as well as between these entities and other entities not shown.

In one embodiment, indexing engine 410 may be configured to construct one or more indexes of file system content, which may include generating index information associated with one or more files 250 as described previously. For example, indexing engine 410 may be configured to construct data structures such as tables or lists including indexing information, and may store such data structures internally or may coordinate to store them via file system 205. Search evaluation engine 420 may be configured to evaluate searches with respect to file system content and to return search results to requesting processes or applications. For example, search evaluation engine 420 may be configured to parse a given search string or pattern, to consult indexes made available by indexing engine 410 in order to quickly identify file system content satisfying the given search pattern, and to provide the names of files 250 satisfying the given search pattern. It is noted that in some embodiments, the functions of indexing engine 410 and search evaluation engine 420 may be provided by a single software module or distributed among a group of other software modules.

In the illustrated embodiment, when generating index information for a given file 250, indexing engine 410 may be configured to include in the generated index information a unique file identifier (or simply, file ID) corresponding to given file 250 as well as a last modification time corresponding to given file 250. In some embodiments, the last modification time of given file 250 may be tracked and stored by file system 205 as metadata within a corresponding named stream 260. For example, file system 205 may update the last modification time of files 250 whenever a file system content access event (such as a write operation) resulting in modification to corresponding file content occurs. Additionally, in some embodiments file system 205 may be configured to assign a file ID to given file 250, which may be stored, for example, as metadata in a corresponding named stream 260. Generally speaking, a file ID may have the property that each file ID corresponds to only one file 250 within file system 205, and vice versa. A file ID assigned to a given file 250 may remain constant while given file 250 continues to exist, regardless of whether given file 250 is moved or renamed within file system 205. One specific embodiment of a file ID is described below in conjunction with the description of FIG. 8.

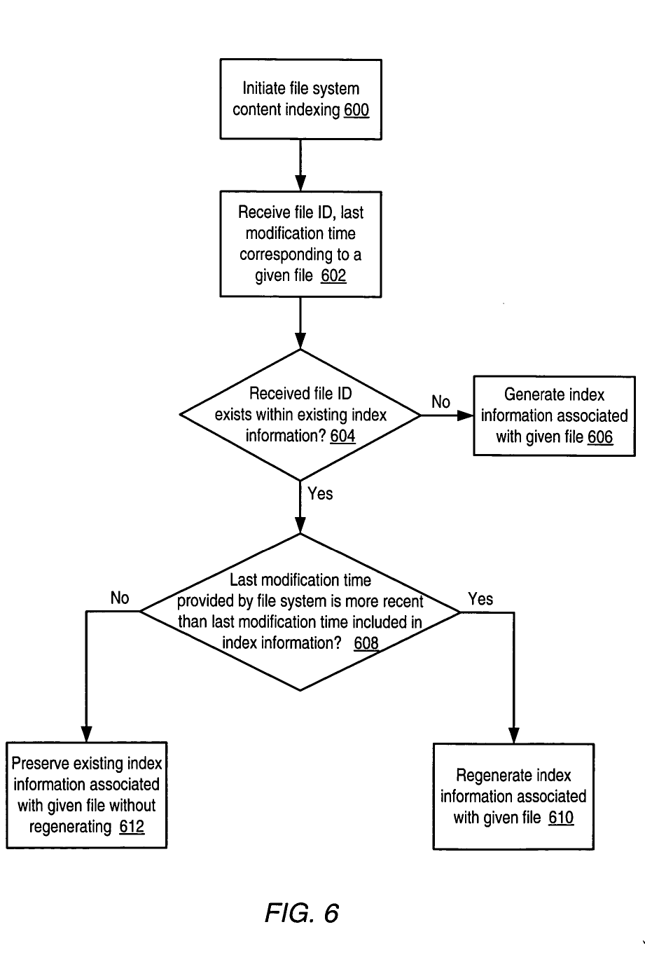

In the embodiment of FIG. 5, the index information generated by indexing engine 410 may not include the pathname or filename of a given file 250, but rather the file ID assigned to given file 250. By indexing on unique file IDs, search engine 400 may be configured to avoid regenerating index information for files 250 that have been moved or renamed as described above. One embodiment of a method of operation of search engine 400 reindexing is illustrated in FIG. 6. Referring collectively to FIG. 1 through FIG. 6, operation begins in block 600 where file system content indexing is initiated. In various embodiments, file system content indexing may be initiated in response to different criteria. For example, in one embodiment, search engine 400 may be configured to scan file system 205 at intervals of time (such as every few minutes, hourly, daily, etc.) in order to identify file system content for which index information may need to be regenerated. Such indexing may occur independently of any specific file system content access events. In another embodiment, search engine 400 may monitor file system content access events, for example such as may be recorded in event log 270 as described above, and may initiate indexing upon detecting certain events.

Once indexing is initiated, search engine 400 may receive a file ID associated with a given file 250 as well as a corresponding last modification time provided by file system 205 (block 602). For example, filter driver 221 may be configured to access named stream 260 associated with given file 250 to retrieve the file ID and current last modification time stored therein, and to convey this information to search engine 400.

Search engine 400 may check existing index information stored within its indexes to determine whether the received file ID associated with given file 250 exists within any existing index information (i.e., whether the received file ID matches a file ID stored within existing index information) (block 604). If the received file ID does not exist, search engine 400 may generate index information associated with given file 250 (block 606). The received file ID and the last modification time provided by file system 205 may be stored within the generated index information.

If the received file ID does exist within some index information, search engine 400 may determine whether the last modification time provided by file system 205 is more recent than the last modification time included within the index information corresponding to the matching file ID (block 608). If the last modification time provided by file system 205 is more recent than the last modification time included within the index information (i.e., if given file 250 was modified since it was last indexed), search engine 400 may regenerate the index information associated with given file 250 (block 610). Otherwise, search engine 400 may preserve the existing index information without regenerating it (block 612).

It is noted that since the file ID associated with given file 250 may remain unchanged if the file is moved or renamed, search engine 400 may not regenerate index information for given file 250 simply because it is moved or renamed.

In the embodiment illustrated in FIG. 5, search engine 400 may be configured to index file system content according to file IDs corresponding to files 250, and may not receive or index file names or pathnames corresponding to files 250. In embodiments where it is desired that search engine 400 provide file names and/or pathnames associated with search results, but such file names and/or pathnames are not present within index information, search engine 400 may be configured to utilize a reverse lookup API provided by file system 205. In the illustrated embodiment, file system 205 may be configured to provide a reverse lookup API that identifies a pathname and/or file name corresponding to a given unique file ID. For example, when the reverse lookup API is invoked, file system 205 may be configured to search named streams 260 to identify a named stream 260 that matches the provided file ID. File system 205 may then obtain pathname/file name information from the matching named stream 260. In other embodiments, file system 205 may maintain indexes or tables to speed reverse lookup of name information from file IDs.

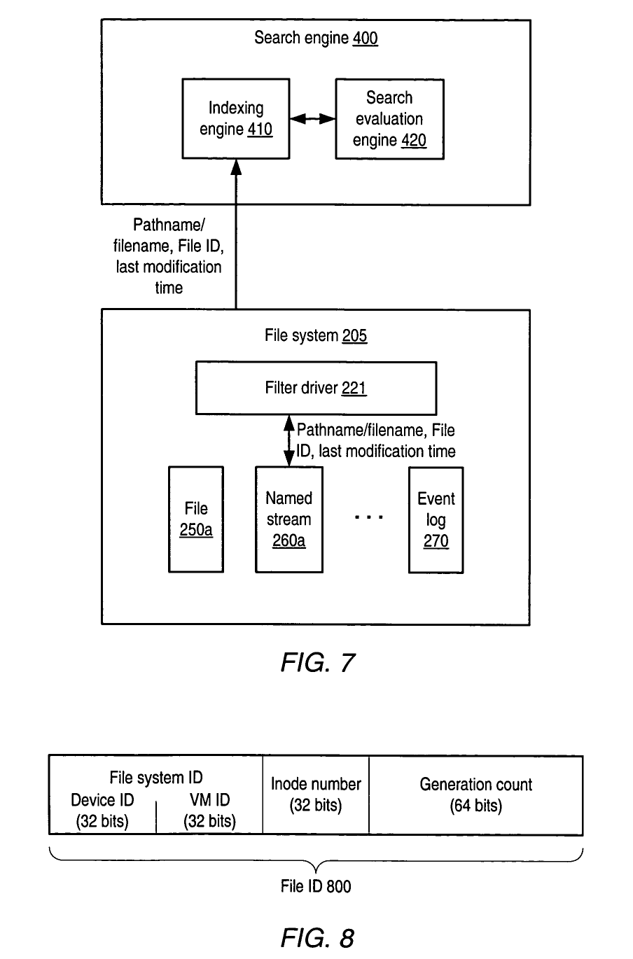

In some instances, a reverse lookup API may be computationally expensive. In an alternative embodiment of search engine 400 illustrated in FIG. 7, the reverse lookup API may be omitted. Instead, indexing engine 410 may index pathname and file name information corresponding to a given file 250 along with file ID and last modification time information during step 602 illustrated in FIG. 6. In this embodiment, searching and indexing may primarily occur with respect to the file IDs stored within index information, similar to the embodiment of FIG. 5. However, when search engine 400 evaluates a given search pattern to obtain a result set, the index information corresponding to each file referenced in the result set may include both the file ID and the corresponding name information. Thus, the file name and/or pathname for each file 250 in a given search result set may be obtained by search engine 400 directly from the index information associated with the resulting files 250, without necessitating a reverse lookup by file system 205.

In one embodiment, indexing within the embodiment of FIG. 7 may generally proceed according to the flow chart illustrated in FIG. 6, with the following addition: in block 612, after having determined in block 608 that the last modification time provided by file system 205 is not more recent than the last modification time included within the index information (i.e., if given file 250 was not modified since it was last indexed), search engine 400 is configured to replace the pathname and/or file name included in the index information associated with given file 250 with the pathname and/or file name provided for given file 250 by file system 205. (In some embodiments, search engine 400 may conditionally perform this replacement dependent upon whether the provided pathname/file name information differs from that stored within the index information.) Thus, if given file 250 has been moved or renamed since it was last indexed, but not otherwise modified, its pathname/file name information may be updated within its associated index information, but the existing index information may be preserved without being regenerated from given file 250.

One example of a unique file ID that may be assigned to a file 250 by file system 205 is illustrated in FIG. 8. In the illustrated embodiment, file ID 800 includes three concatenated fields: a 64-bit file system identifier (ID), a 32-bit inode number, and a 64-bit generation count. The file system ID further includes a 32-bit device ID and a 32-bit volume manager ID (VM ID). It is contemplated that in other embodiments, file ID 800 may include additional or different types of fields, and that the fields may be of other widths.

In one embodiment, the file system ID may correspond to the logical and physical devices on which a given file system managed by storage management system 200 may reside. In the illustrated embodiment, the device ID may correspond to a specific device managed by one of device drivers 224 on behalf of storage management system 200. For example, the device ID may include a major and/or minor number, or another suitable type of device identifier. In some embodiments, device IDs may correspond to individual physical hardware devices such as storage devices 230, while in other embodiments device IDs may correspond to logical devices that include further layers of abstraction on top of physical hardware devices.

In some embodiments, a given device may be further organized into one or more volumes, which may then be associated with particular file systems. In such embodiments, a volume manager (VM), which may be included within file system 205 or may logically reside between file system 205 and device drivers 224, may assign a VM ID to a volume, which may be incorporated into the file system ID as shown in FIG. 8.

The inode number may denote one of a pool of inodes managed by file system 205. Generally speaking, an inode is a data structure a file system may use to manage information about individual files (such as the physical location of a given file on a particular device or volume). An inode may be assigned to a particular file 250 when the file is created, and released when the corresponding file 250 is deleted. In some embodiments, inodes may be reused. For example, an inode denoted by a particular inode number X may be assigned to a file Y, which is then deleted. During a subsequent file create operation, inode number X may be assigned to the newly created file Z.

While in some embodiments identical inode numbers may be reused for different files 250, in the illustrated embodiment of file ID 800, the generation count may be used to distinguish inodes that have been so reused. For example, in one embodiment, the generation count corresponding to a particular inode may be incremented whenever the particular inode is newly assigned or allocated to a file 250. Thus, referring to the above example, although inode number X may be associated at various times with files Y and Z, the generation count associated with inode number X may differ at those various times by at least 1.

It is noted that by concatenating each of the various fields described above, the uniqueness of the resulting file ID 800 may be probabilistically ensured rather than absolutely guaranteed. That is, it may be mathematically possible to generate the same file ID for two different files 250, but the probability of such a file ID being generated may be negligibly small. For example, in the illustrated embodiment, if a given one of 2³² inodes were reused 2⁶⁴ times, the generation count might wrap back around to a previously used value. However, such an occurrence is highly unlikely to occur. Further, file system 205 may be configured to detect such a case and to respond accordingly in order to prevent any side effects that might arise, such as by generating an error condition or checking for any system dependencies on the previously occurring file ID value (such as existing index information).

Additionally, it is contemplated that any of the elements illustrated in FIG. 2-7, including file system 205, search engine 400, and their various methods of operation, may be implemented as program instructions and data stored and/or conveyed by a computer-accessible medium as described above.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system, comprising:
a storage device configured to store data; and
a file system configured to manage access to said storage device and to store file system content, wherein said file system content includes a file associated with a pathname; and
a search engine configured to construct an index of said file system content, wherein constructing said index includes generating index information associated with said file;
wherein in response to said file being moved or renamed, said search engine is further configured to preserve existing index information associated with said file without regenerating said existing index information.

2. The system as recited in claim 1, wherein said file system is further configured to assign a unique file identifier to said file.

3. The system as recited in claim 2, wherein said index information includes said unique file identifier and a last modification time corresponding to said unique file identifier, and wherein said search engine is further configured to search file system content by unique file identifiers.

4. The system as recited in claim 3, wherein said search engine is further configured to regenerate said index information associated with said file in response to determining that a last modification time corresponding to said unique file identifier and provided by said file system is more recent than said last modification time included in said index information.

5. The system as recited in claim 3, wherein said index information further includes said pathname associated with said file, and wherein said search engine is further configured to replace said pathname included in said index information with a pathname provided by said file system.

6. The system as recited in claim 3, wherein said file system is further configured to provide an application programming interface (API) configured to identify a pathname corresponding to a given unique file identifier, and wherein said search engine is further configured to utilize said API to obtain pathnames corresponding to unique file identifiers resulting from searching file system content.

7. The system as recited in claim 2, wherein said unique file identifier includes a file system identifier, an inode number, and a generation count.

8. A method, comprising:
storing file system content, wherein said file system content includes a file associated with a pathname;
constructing an index of said file system content, wherein constructing said index includes generating index information associated with said file; and
in response to said file being moved or renamed, preserving existing index information associated with said file without regenerating said existing index information.

9. The method as recited in claim 8, further comprising assigning a unique file identifier to said file.

10. The method as recited in claim 9, wherein said index information includes said unique file identifier and a last modification time corresponding to said unique file identifier, and wherein the method further comprises searching file system content by unique file identifiers.

11. The method as recited in claim 10, further comprising regenerating said index information associated with said file in response to determining that a last modification time corresponding to said unique file identifier and provided by a file system is more recent than said last modification time included in said index information.

12. The method as recited in claim 10, wherein said index information further includes said pathname associated with said file, and wherein the method further comprises replacing said pathname included in said index information with a pathname provided by a file system.

13. The method as recited in claim 10, further comprising:
providing an application programming interface (API) configured to identify a pathname corresponding to a given unique file identifier; and
utilizing said API to obtain pathnames corresponding to unique file identifiers resulting from searching file system content.

14. The method as recited in claim 9, wherein said unique file identifier includes a file system identifier, an inode number, and a generation count.

15. A computer-accessible medium comprising program instructions, wherein the program instructions are executable to:
store file system content, wherein said file system content includes a file associated with a pathname;
construct an index of said file system content, wherein constructing said index includes generating index information associated with said file; and
in response to said file being moved or renamed, preserve existing index information associated with said file without regenerating said existing index information.

16. The computer-accessible medium as recited in claim 15, wherein the program instructions are further executable to assign a unique file identifier to said file.

17. The computer-accessible medium as recited in claim 16, wherein said index information includes said unique file identifier and a last modification time corresponding to said unique file identifier, and wherein the program instructions are further executable to search file system content by unique file identifiers.

18. The computer-accessible medium as recited in claim 17, wherein the program instructions are further executable to regenerate said index information associated with said file in response to determining that a last modification time corresponding to said unique file identifier and provided by a file system is more recent than said last modification time included in said index information.

19. The computer-accessible medium as recited in claim 17, wherein said index information further includes said pathname associated with said file, and wherein the program instructions are further executable to replace said pathname included in said index information with a pathname provided by a file system.

20. The computer-accessible medium as recited in claim 17, wherein the program instructions are further executable to:
provide an application programming interface (API) configured to identify a pathname corresponding to a given unique file identifier; and
utilize said API to obtain pathnames corresponding to unique file identifiers resulting from searching file system content.

21. The computer-accessible medium as recited in claim 16, wherein said unique file identifier includes a file system identifier, an inode number, and a generation count.
